(19) United States
(12) Patent Application Publication
(10) Pub. No.: US 2008/0127890 A1
(43) Pub. Date: Jun. 5, 2008

(54) DEVICE FOR APPLYING PLASTIC TO A WORKPIECE

(76) Inventors: Johann Karl, Mertingen (DE); Claus Hetzner, Zirndorf (DE)

Correspondence Address: ST. ONGE STEWARD JOHNSTON & REENS, LLC, 986 BEDFORD STREET, STAMFORD, CT, 06905-5619, US

(21) Appl. No.: 11/877,980

(22) Filed: Oct. 24, 2007

(30) Foreign Application Priority Data
Oct. 26, 2006 (DE) 10 2006 050 543.3
Feb. 9, 2007 (DE) 10 2007 007 139.8

(51) Int. Cl. B05B 7/00

(52) U.S. Cl. 118/300

(57) ABSTRACT

A device for applying plastic onto a workpiece, consisting of a supply area to insert flowing plastic, a distribution area which follows the supply area in the flow direction of the plastic, and a nozzle area which follows the distribution area, wherein a circular opening in the device is surrounded by an annular outlet in the nozzle region, and a workpiece that is arranged within the opening is moveable in an axial direction with respect to the outlet and can be covered with plastic over its entire circumference. A device for the application of plastic is provided herein, which makes possible a uniform application over the entire circumference, even for large workpieces.

### CROSS-REFERENCE TO RELATED APPLICATIONS

The present application claims priority of German patent application Nos. 10 2006 050 543.3 filed on Oct. 26, 2006 and 10 2007 007 139.8 filed on Feb. 9, 2007, the content of which is incorporated herein by reference.

### FIELD OF THE INVENTION

The invention concerns a device for applying plastic to a workpiece. Additionally, the invention concerns a method for producing a plastic corrugated pipe by means of the inventive device as well as the plastic pipe produced by this method.

### BACKGROUND OF THE INVENTION

EP 1 243 400 B1 describes a device for producing corrugated pipes which will allow the production of an indefinite number of plastic pipes with corrugated surfaces by means of an extruder device and a subsequent molding segment. Such corrugated surfaces provide good pipe ring stiffness for the least amount of material. It may be desirable to cover these or similar pipes with an additional outer coating of plastic, depending on the specific request.

It is the invention's task to provide a device for the application of plastic to workpieces which makes possible a uniform application in the circumferential direction for large workpieces.

### SUMMARY OF THE INVENTION

This task is achieved by the inventive device with the features in Claim 1. An especially uniform application of plastic in the circumferential direction of the workpiece is made possible by a distribution area with a ring-shaped outlet.

In the preferred embodiment, the supply region includes a first, tubular supply line which branches into a number of secondary supply lines. In this way, the supply region can receive the first allocation of the plastic into at least two supply lines, and said plastic is ultimately to be applied as homogeneously as possible over the surface. It is preferred that at least one of the secondary supply lines branch into a number of tertiary supply lines, so that at least three and preferably four separate, evenly applied supply lines are present over the surface. The lines of the respective branching planes can then be reduced I cross-section, depending on the distribution of the flow of plastic.

It is also advantageous if the supply region contains a number of distribution channels extending outwards from it in the circumferential direction of the circular opening. Thereby, the distribution channels are advantageously branched into at least one distribution plane. In this way, an additionally branching pre-allocation over the surface of the workpiece becomes possible even in the phase of the plastic supply.

In the interests of achieving simple and effective production with easy maintenance access, the distribution plane contains a number of plate elements, where the distribution channels are molded to the plate elements. It is useful for the plate elements to be arranged on top of one another in the axial direction, so that the channels can be developed as grooves or bores in the circumferential direction.

In a preferred embodiment, in order to guarantee sufficient pre-allocation of the plastic in the supply phase, particularly for workpieces with large diameters, the plastic flows from the supply region to the distribution region over at least 16, particularly at least 32, canals distributed in the circumferential direction of the opening. In a generally advantageous manner, the number of input points corresponds to a power, of 2.

In a preferred embodiment of the invention, the distribution area has a ring-shaped cavity, so that the plastic flows into the cavity through a number of supply canals distributed in the circumferential direction and exits from the cavity through an annular gap. The circular cavity primarily brings about a homogenization of the plastic flow, so that the annular gap receives an even flow from the regularly highly viscous material. In an advantageous embodiment, the cavity has a decreasing cross-section in the radial direction from the outside inwards. In this way, the passage cross-section for the plastic flow decreases in the direction of the flow, which leads to the desired backlog. Particularly importantly, the cross-section takes the form of a triangle shrinking in the radial direction. The plastic has a main direction of flow in the distribution area cavity which runs radially from the outside inwards; a flow in the circumferential direction can be superimposed over this main direction of flow. It has been shown that this configuration allows good homogenization of the plastic to be achieved with a relatively small space available for the distribution area, especially for workpieces with large diameters. In addition, this solution is simple to produce and mechanically stable even at high pressure.

In an advantageous refinement, the cavity has a wall with a number of spiral grooves. The plastic mass is admitted into these grooves with a flow in the circumferential direction, where manipulation of the individual flow sections takes place depending on the construction of the grooves in order to assure good homogenization of the plastic. For this purpose, the wall preferably makes an angle with the radial plane, perpendicular to the axial direction, which is less than about 45°, particularly less than 30°, particularly between about 18° and 25°.

A simple possibility for fine-tuning of the plastic flow in the distribution area is offered when at least a few, particularly all, of the supply canals have a throttle element for adjusting the cross-section of the canal. In a simple construction, each throttle element can have an adjusting screw protruding into the canal. The throttle elements are advantageously distributed around the periphery of the device and should be adjustable from the outside so that, in particular, adjustments of the throttle elements can be made while the device is in use. In this way, it is possible, even during application, to react to changes due to temperature or fouling in the areas where the plastic is flowing.

In a simply constructed realization, the distribution area includes a ring-shaped distribution disk, where a wall of the cavity is molded to the distribution disk on the axial front side. The supply canals to the cavity are then configured as axial bores appropriately distributed over the distribution disk. If the supply canals are furnished with throttle elements, they can functionally include radial thread canals, through each of which an adjustment screw feeds into the supply canals.

In an advantageous embodiment of the invention, the nozzle area has a rotationally symmetric annular gap in the axial direction, so that the plastic flows from the distribution area through the annular gap to the outlet. The annular gap does not have a stud in its path, so that the homogenization of the plastic flow in the circumferential direction is not affected.

In the preferred embodiment, the annular gap has at least a first and a second segment, where the first section runs axially and the second at an angle to the axial direction. By thus dividing the annular gap into different sections, an additional optimization of the plastic flow can be achieved, particularly regarding changes in pressure and flow velocity. It is particularly preferred that at least one of the two segments has a decreasing cross-section throughout its path, to ensure the desired back-up of the plastic.

In a particularly optimal embodiment, the first segment of the annular gap comes after the distribution area in the direction of flow and the second segment follows the first segment, and the second segment has conical walls with varying cone angles.

In a more complete implementation, the annular gap also has a back-up ring area, where a local decrease in cross-section of the annular gap is configured through the back-up ring area. In this way, a targeted back-up of plastic is possible at an appropriate distance from the outlet. The cross-section decrease can, for example, be formed by an axially cylindrical gap of particularly small passage cross-section or as a ring-shaped projection which protrudes locally into the opening in order to decrease the cross-section.

In a preferred implementation, the outlet opening is configured as the last segment of the annular gap, so that the outlet has a conical wall angled radially inwards in the direction of flow of the plastic. In an advantageous embodiment, the outlet opening has two conical walls with different cone angles, and the cross-section of the outlet narrows in the direction of flow of the plastic. Thus, in a simple way, the plastic flow is particular uniform and free of fluctuation.

In order to make adjustments possible and in the general interest of simple production, the outlet opening is placed between the first ring element and the second ring element in the nozzle area. It is particularly preferred that the outlet be adjustable through mobility of at least one of the ring elements.

In an advantageous implementation, the mobility is effected by the elastic malleability of the ring element by means of radial prestressing tendons. In a simply constructed realization, the tendons consist of a number of clamping bolts distributed radially around the periphery of the ring element, and the clamping bolts are adjustable, especially when the device is in use. Owing to this possibility of radially deforming at least one of the ring elements, the homogeneity of the material flow can be optimized in the circumferential direction, to compensate for changes during operation, for example pressure distribution or mechanical deformation due to pressure and temperature.

Alternatively or complementarily, it is intended that the first ring element and the second element be adjustable relative to one another in the axial direction. In this way, this size of the outlet opening can be modified over the entire device. In a simple configuration, modifiable spacing elements are placed with one of the ring elements to adjust the distance between it and the second ring element.

Alternatively or complementarily to the changeable spacing means, the first ring element can be adjusted to at least one thread relative to the second ring element. In this way, a simple and continuous adjustment is possible which, depending on the design, can also be carried out while the device is in use.

In a particularly preferred implementation, a second thread is included, so that the first and second threads have a different pitch. In this way, a differential thread is made possible, so that a differential thread can generally make fine adjustments in distance possible. In a simply constructed realization, a threaded ring that can be rotated for axial adjustment works together with the two threads. The first ring element and the second element are then controlled by an axial guide element so that they can move axially with respect to one another. In this way, a particularly precise compulsory control becomes possible, which limits the relative mobility precisely in the axial direction. The axial guide element can consist simply of guided bolts that move in bore holes by sliding and with as little free play as possible.

It is generally preferable for the device to have a means of heating to heat the surface of the workpiece. In this manner, the surface of the workpiece can be heated to a specific temperature before the application of the plastic. This makes it possible to pre-melt the surface, especially of workpieces made from thermoplastic materials, so that the applied plastic can form a good adhesive, molecular binding with the surface. Appropriate means of heating include electrical resistance heating, especially ceramic heating, or radiant heating systems with light, lasers, infrared radiation, microwaves, or similar means. Hot air heating or other suitable heating systems are also possible.

In a preferred implementation, the device has at least one elastic scraper positioned so that it can slide and is contiguous with the workpiece. The workpiece can be guided by such scrapers. In particular, this can result in a seal that is at least roughly airtight, creating a closed and pressurized cavity between workpiece, plastic flow, and device. In this way, it becomes possible to mold the soft plastic hose in the course of the task. This is particularly important when cavities and furrows are trapped in the workpiece by the applied plastic, as the gas pressure in these cavities can be adjusted in this way.

In a particularly preferred detailed implementation, the workpiece is a corrugated pipe, where the applied plastic forms an essentially smooth exterior wall of the corrugated pipe. The corrugated pipe preferably has a smooth interior wall. Such corrugated pipes with smooth interior walls are well known and are in growing demand because they have many uses, for example as canalization pipes, and. Until now, the application of an additional smooth layer from the outside has been problematic, especially in the case of pipes with large diameters.

The plastic preferably consists of a polyolefin or another plastic with good stability when heated.

In a preferred implementation, the workpiece is a pipe with an outer diameter of at least 700 mm. It is particularly preferred that the outer diameter of the pipe should be greater than 1200 mm, especially around 1800 mm. It has been shown that a device of the inventive construction is particularly suited for the application of a layer of plastic to very large pipes, where the applied layer is very homogenous, especially in the circumferential direction.

In another preferred embodiment of the invention, distribution area is intended to have a ring-shaped cavity, so that the plastic flows into the cavity through a number of supply canals distributed around the circumference and exits the cavity through a surrounding annular gap. In this way, the cavity preferably has an inner side wall shaped to an inner distribution part and, opposite it, an outer side wall shaped to an outer distribution part, so that each of the side walls essentially has the form of a conical section. Because of the conical-section form of the two walls, the cavity is angled as a whole with respect to the axial direction, which will typically be directed radially inward in the direction of flow of the plastic. This results in a particularly advantageous pressurized flow of the plastic in the cavity. The advantageous pressurized flow allows for a particularly flexible configuration of the nozzle area with an unchanged distribution area.

At least one groove extending essentially in the circumferential direction is configured on at least one of the two side walls, particularly the inner side wall, to improve the distribution and homogenization of the plastic.

In order to achieve an advantageous pressurized flow in the distribution area, there should be an angle between one of the side walls and the axial direction of 10 to 45 degrees, preferably between 20 and 30 degrees. In a particularly preferred implementation, the side walls shaped like conic sections have different cone angles from one another, so that the difference between the cone angles is not more than 5 degrees, preferably 3 degrees. In order to improve the pressurized flow, this angle between the two conic section side walls must be selected so that the radial distance between the side walls increases in the direction of flow of the plastic.

In an appropriately constructed embodiment, the annular gap is at least partially placed between an inner ring element and an outer ring element, and the outer ring element is configured to be adjusted by a spacing element. In this way, a corresponding adjustment, preferably an adjustment even during the manufacturing phase, can be made to set a desired wall strength for the plastic webs exiting from the annular gap. In a simple realization, the spacing element consists of a radially working actuator that is supported against the outer spacing element.

In an appropriate embodiment of the invention, an end area of the annular gap is bounded by another ring element. It is particularly preferable for the additional ring element to be adjustable by a spacing element, so that in particular in versions with relatively long nozzle areas, multi-position adjustability of the annular gap is possible in at least two areas. The spacing element of the additional ring element for this purpose has a radially working adjustment piece that is supported in particular against the outer ring element.

In an especially preferred implementation, the ring-shaped cavity has a diameter of more than 1700 mm, and in particular more than 1800 mm. The special characteristics of the inventive device thus allow a uniform and therefore high-quality application of a plastic coating over such large diameters. The annular gap preferably has a diameter of more than 1600 mm at the exit end, and in particular more than 1700 mm. In general the plastic piece that is created here should have a diameter that is only slightly less than that of the exit side cavity diameter.

Another preferred embodiment of the invention encompasses a first set of ring elements, and at least a second set of ring elements, in which each of the sets of ring elements can be detachably secured to the distribution area, and the annular gap is shaped by the set of ring elements secured on each distribution area. In this way, at least in the given distribution area where the diameter has not been changed depending on the applied set of ring elements, plastic parts of various diameters can be coated. This appreciably raises the flexibility and the cost efficiency of the inventive device. In the preferred detailed embodiment, therefore, the first set of ring elements has a first diameter of the exit end of the annular gap, which is to be distinguished from a corresponding second diameter of the exit end of the annular gap of the second set of ring elements.

Preferably, the first diameter is here larger than about 1600 mm, and especially larger than 1700 mm. It is further preferred that the second diameter be smaller than about 1200 mm, and in particular smaller than about 1000 mm.

Thanks to these particular large differences in the diameter of ring element sets, economies in the costs of components can be expected, since the number of ring elements of the first set of ring elements is different from the number of ring elements of the second set of ring elements. In this way in general a ring element set with a large diameter of the annular gap includes fewer ring elements, since a shorter nozzle area is made possible because of the diameter similar to that of the distribution area.

The invention also relates to a method for manufacturing a plastic corrugated pipe, including the steps for feeding a plastic corrugated pipe into a device according to claims 1 to 59, and for applying a plastic coating on the fed-in corrugated pipe by means of the device. In particular corrugated pipes with an essentially smooth outer wall can be manufactured with such a process.

The invention, in addition, relates to a plastic corrugated pipe manufactured in the method according to claim 60. This detailed embodiment of the applied plastic coating forms an essentially smooth outer coating of the corrugated pipe.

Other advantages and characteristics of the invention can be seen from the following description of the embodiment and from the associated claims.

Hereafter several preferred embodiments of the inventive device are described and further discussed on with reference to the appended drawings.

### BRIEF DESCRIPTION OF THE DRAWINGS

FIG. 1 shows a sectional view of a first embodiment of the inventive device along line A-A of FIG. 3.

FIG. 2 shows a spatial presentation of the device from FIG. 1.

FIG. 3 shows an overhead rear view of the device from FIGS. 1 and 2.

FIG. 4 shows an overhead view of the distribution disk of the device from FIG. 1.

FIG. 5 shows a sectional view of the distribution disk from FIG. 4 along the line A-A.

FIG. 6 shows a partial spatial presentation of the distribution disk from FIG. 4.

FIG. 7 shows a detail enlargement of the device from FIG. 1.

FIG. 8 shows a partial sectional presentation of a second embodiment of the inventive device.

FIG. 9 shows a partial sectional view of a third embodiment of the inventive device.

FIG. 10 shows a sectional view of another embodiment of the inventive device along line A-A of FIG. 3.

FIG. 11 shows a variation of the device from FIG. 10.

### DETAILED DESCRIPTION OF THE INVENTION

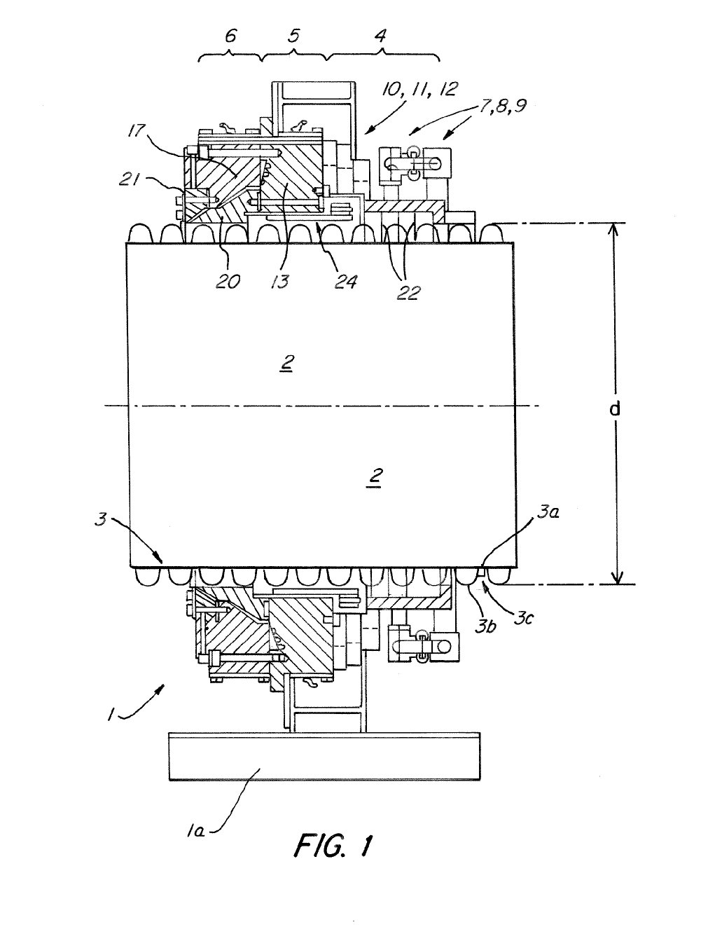

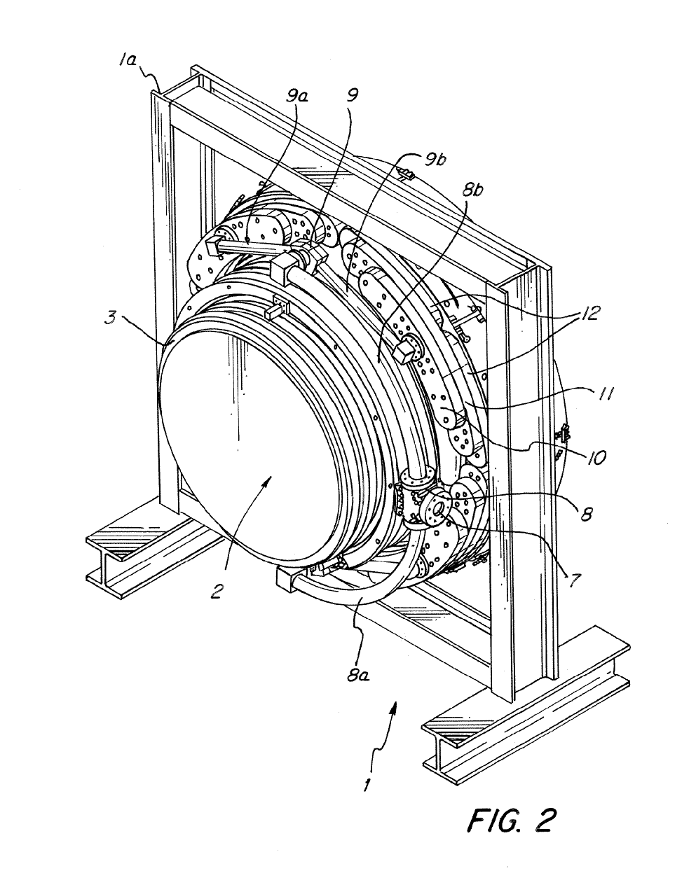

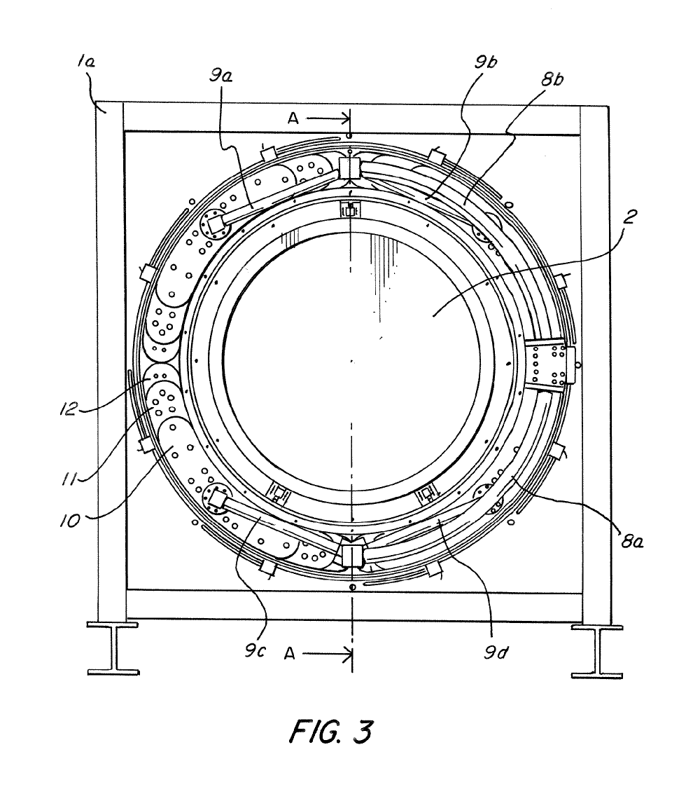

The inventive device according to the first embodiment from FIG. 1 includes a primarily ring-shaped enclosing head 1, which is held in a carrier frame 1a. The enclosing head has a continuous circular central opening 2, through which the workpiece 3 can be moved. The workpiece is predominantly a corrugated pipe 3 of plastic, in particular a polyolefin. The corrugated pipe 3 has a smooth inner layer 3a and a corrugated outer layer with corrugated peaks 3b and corrugated valleys 3c. The corrugated pipe has an outer diameter d of about 1700 mm. FIGS. 1 to 7 are each drawn to scale, so that the essential dimensions of the device can be deduced from the corresponding scaling.

To apply a plastic layer, the workpiece 3 is moved through the opening 2 in an axial direction, and thus according to the presentation in FIG. 1 from right to left.

The enclosing head 1 has a supply area 4, a distribution area 5, and a nozzle area 6, placed successively in the axial direction, and each of which can be passed through the heated and flowing plastic material.

The supply area 4 comprises a primary main supply line 7, through which a plastic material that arrives from an extruder (not shown in the illustration) is inserted into the device under pressure. In the supply area, this current of plastic material is divided into a total of 32 partial paths that are essentially of equal size.

For this purpose, beginning from the main line 7, the supply area 4 comprises a first distribution piece 8, which divides the flow into two secondary supply lines 8a, 8b. Each secondary supply line 8a, 8b flows to distribution pieces 9, in which the flow is then divided into a total of four tertiary supply lines 9a, 9b, 9c, 9d. In this way, a first distribution area is formed based on multiply branched discrete, pipe-like lines 8a, 8b, 9a, 9b, 9c, 9c.

The first distribution area is followed by a second distribution area, in which the flow of the plastic material is further divided up. The second distribution area consists of a number of plate elements 10 that extend in peripheral direction. Each of the four tertiary supply lines 9a, 9b, 9c, 9d flows into one of the four plate elements 10 of a first distribution plane of the second distribution area. Each of plate elements 10 comprises distribution channel that is branched symmetrically in relation to the site of the flow-in (not shown) in the form of a groove so that the number of the plastic material flows is again doubled. Each of the plate elements 10 of the first level is attached, flatly, to a plate element 11 of a second plane, and a corresponding arrangement of boreholes and groove-shaped supply channels of the plate elements 11 results in another doubling of the material flows. Each of the plate elements 11 of the second plate element plane is attached in turn to two of a total number of eight plate elements 12 of a third level, which analogously results in a last doubling of the number of the flow channels to a total of 32 channels.

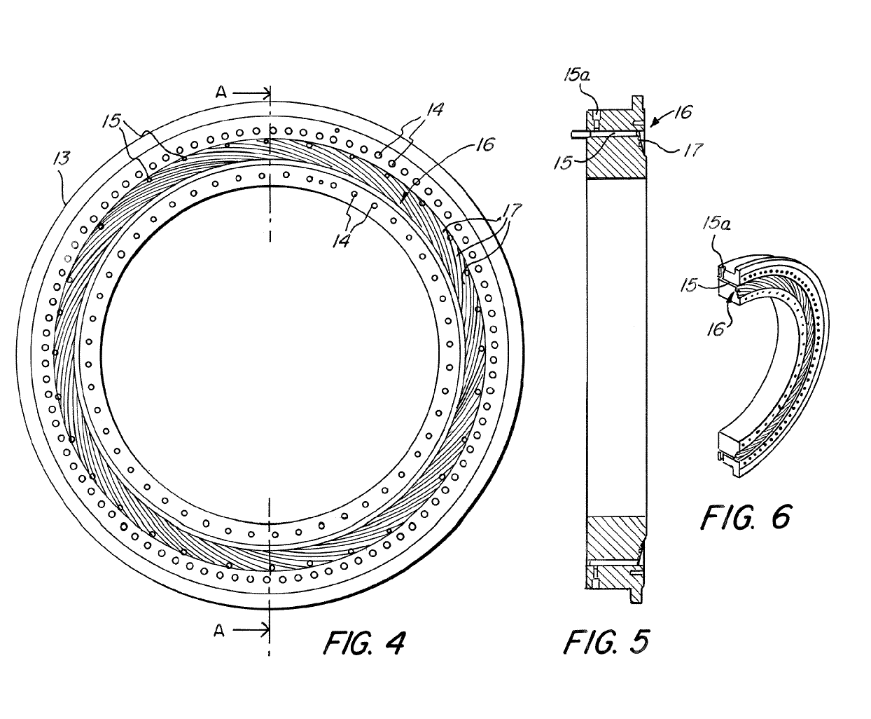

The last plane of plate elements 12 is screwed axially to a ring-shaped distribution disk 13. A detailed illustration of the distribution disk 13 is shown in FIGS. 4 to 6. The distribution disk 13 comprises a number of boreholes and/or threaded blind holes 14 to assemble the plate elements 12 adjacent on one side and the ring elements adjacent at the other side (See subsequent description).

In addition, the distribution disk 13 comprises 32 axial channels 15 configure as boreholes that are arranged in a peripheral circle at regular intervals and are connected to the 32 supply channels, designed as grooves, of the last plane of the plate elements 12. A punched hole 15a with a thread coming in radial direction from outside leads into each of the axial channels 15. These punched threaded holes 15a comprise setting screws (not shown) that extend in the corresponding radial direction and are accessible from outside. Depending on the adjustment of the setting screw, the free cross-section of each of the axial channels 15 can be modified so that the punched holes 15a together with setting screw function as a throttle element.

An axial front surface of the distribution disk 13 is structured on the side of the distribution disk 13 that is opposite the plate elements 12. The structure comprises a wall 16 that is inclined in the cross-section as shown in FIG. 5, namely a wall 16 in the shape of a conical segment, and this wall 16 comprises a number of spiral-shaped grooves 17. Each of the grooves 17 extends over an angular segment of about 35-40 degree from the upper to the lower ends of the wall 16. Over this course, the axial depth of the grooves levels off (see cross-section, FIG. 5). The 32 channels 15 end in the upper or radially external end area of the wall 16. The inclination of the wall in relation to the radial direction (or the plane of FIG. 4) is about 22 degrees. In particular the values of the angular segments of the course of the grooves 17 indicated here and the inclination of the wall 16 are only indicative and can assume other values depending on the optimization of the device.

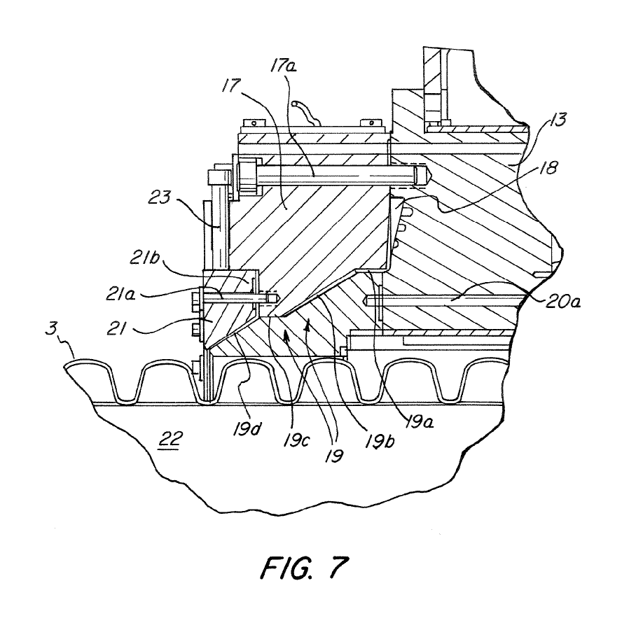

The end face of the distribution disk 13 that is structured with the wall 16 is adjacent to an essentially planar side of the upper ring element 17 that is bolted to the distribution disk 13 by bolts 17a so that the wall 16 a the ring element 17 form a hollow space 18 (see the enlarged illustration in FIG. 7), which in the cross-section has essentially the form of a radially inward-pointing acute triangle.

This hollow space 18 functionally forms the main part of the distribution area 5 of the device. The plastic material that is fed through boreholes 15 to 32 points of entry, which are evenly distributed in a circle, flows through the hollow space 18 essentially in radial direction from outside inwards, and, in addition, the spiral-shaped grooves 17 create a flow component in the peripheral direction. This allows proper homogenization of the flow of the plastic material, which was first discreetly distributed to 32 channels in the peripheral direction.

The radially inside end of the hollow space 18 or the peak of the triangle leads into an angular gap 19 that extends uninterruptedly in peripheral direction and defines the nozzle area 6 of the plastic material flow.

The walls of the angular gap 19 are formed by the surfaces of a total of three ring elements, namely the ring element 17 firmly bolted to the distribution disk 13, an inner ring element 20 that is also attached to the distribution disk 13 with bolt 20a extending beyond the distribution disk 13, and finally a front ring element 21 bolted to the upper ring element with a bolt 21a. Because of corresponding shaping of the opposite surfaces of the ring elements 17, 20, 21 that are distanced so as to form the angular gap 19, the gap forms a path that is optimal for the flow of the plastic material:

The radially inner top of the hollow space 18 is adjacent to a first segment 19a that extends in the axial direction, that is, has the shape of a cylinder sleeve and has a constant flow cross-section. Then follows a second segment 19b, which extends in the flow direction conically and in radial direction inwards, and the two conical wall sections of the involved ring elements 17, 20 have a different cone angle. Consequently the gap narrows down over its course so that its passage cross-section decreases with the flow path more rapidly than in a linear fashion.

Adjacent to this double conical second segment 19b, there is in turn a back-up area 19c in the form of an axial segment, which has a reduced cross-section area due to the distance between the walls.

The gate ring area 19c is followed finally by an outlet 19d, which narrows down similarly as the second segment 19b double conically and from which the plastic material exits. The outer conical wall of the outlet 19d is formed by the front ring element 21. The distancing elements 21b in the form of inserted spacing disks or a single spacing ring are located between the front ring element 21 and the upper ring element 17. This allows adjustment in the size of the outlet 19d.

Contiguous to the outlet 19d is an elastic scraper 22, which slides on the undulated surface of the corrugated pipe 3. In addition, on the other end of the device at the level of the supply area 4, there are additional scrapers 22 so that a closed space is formed between the inner wall of the device and the outer wall of the workpiece 3. Depending on the configuration, the space can also be closed off at one side by the exiting plastic material. The application of the plastic material can be influenced by targeted application of pressure using provided gas channels (not shown). For example, the gas pressure can be adjusted in the closed areas between the applied plastic material and the troughs of the corrugation ribs in order to achieve the desired concave, convex, or flat surface in the area of the ripple troughs after cooling off the plastic material.

Moreover, a number of tensioning screws 23 that are distributed around its circumference and held in radial threaded boreholes of the upper ring exert force upon the front ring element 21. In their entirety, the tensioning screws 23 provide a tensioning element, which allows an essentially radial deformation of the front ring element 20 so that the size of the outlet 19d can be changed in the direction of its circumference. This allows fine-tuning of the plastic material flow also during the operation in order to guarantee a defined thickness of the applied coat that is also constant over the entire layer.

Furthermore, inside the opening 2 the device comprises a heating element 24, which is positioned at a short distance from the surface of the workpiece 3. The heating element 24 warms up the surface of the workpiece, primarily a corrugated pipe made of plastic material, and especially melts it down so that the applied plastic material creates a firm connection with the surface. For this purpose, the workpiece and the applied plastic material are ideally made of the same material or of suitable pairs of materials.

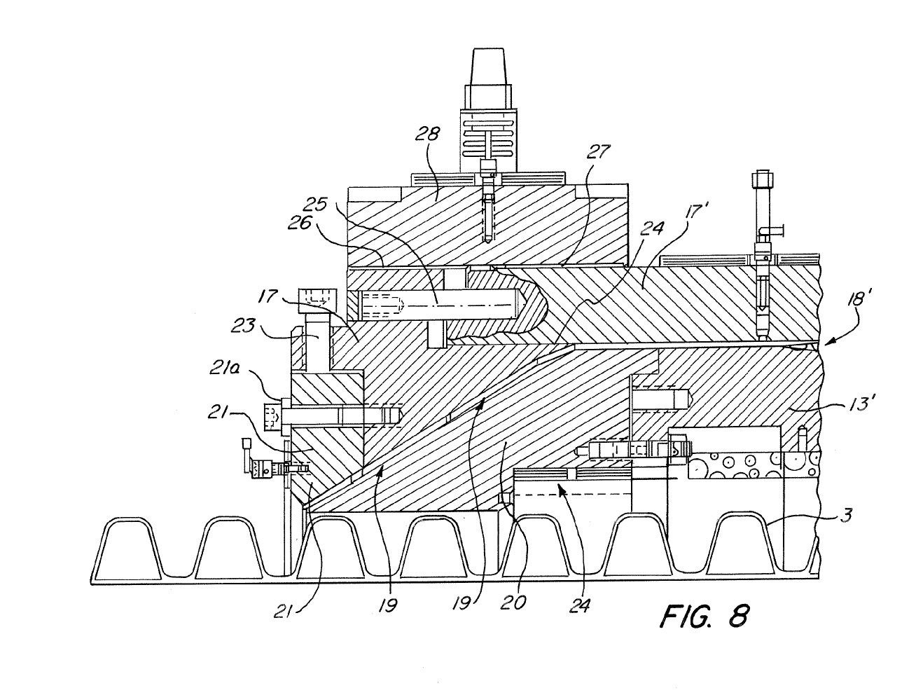

A variant of the first embodiment is shown in FIG. 8. Functionally similar components are labeled with the same reference marks. A substantial difference consists in the fact that the size of the angular gap 19 can be continuously modified by means of a thread, especially during the actual operation. For this purpose, the upper ring element 17 is designed in two parts, and the stationary part 17′ is firmly attached to a differently formed distribution disk 13′ and the rest of the device. A movable part 17 is adjacent to the stationary part through an axial cylinder surface 24 and can be shifted in the axial direction. The front ring element 21 is in turn firmly connected to the movable ring element component 17 and, together with the part 17, can thus be moved in axial direction in relation to the stationary part 17′ and a likewise firmly attached lower ring element 20. This axial movement changes the size of the annular gap 19.

The movable part 17 can move in axial direction by means of guide elements in the form of pivots 25. The ring element parts 17, 17′, which can move in relation to each other, comprise on their outer circumference a first outer thread 26 and a second outer thread 27, and the two threads have a slightly different pitch. A ring nut 28 engages, with correspondingly opposite thread areas at the same time, in the corresponding threads 26, 27. Thus, by turning the ring nut 28, which spans the device on its circumference, one can make especially fine adjustments of the annular gap 19 in the manner of a differential thread.

In the variant shown in FIG. 8, the hollow space 18′ of the distribution area extends essentially in the axial direction and not in the radial direction. However, a threaded adjustment element for the annular gap 19 can also be arranged in the first embodiment without any problem. For this purpose, the upper ring element 17 can be cut apart, for example, at the level of the end of the first segment 19 analogously to the cylinder surface 24 and thus separated into a stationary and a movable part.

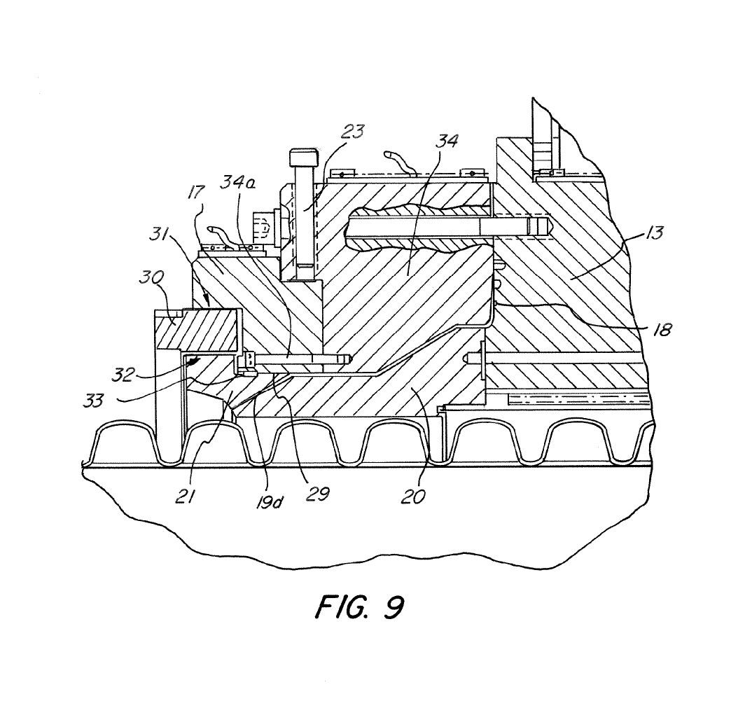

Another variant of the embodiment is shown in FIG. 9. Compared to the first embodiment, the only substantial change is the continuous adjustability of the outlet 19d, which is designed in a manner similar to the aforementioned adjusting option of the second embodiment.

Here, the front ring element 21, which forms the radial outer wall of the outlet 19d, is not firmly bolted to the upper ring element 17 as in the first embodiment, but can be moved in axial direction in relation to this upper ring element 17. The movement is exerted by force over mutually overlapping cylindrical guide surfaces 29, and, as in the second embodiment (there, the cylinder surface 24) the overlapping and contact of the cylinder surfaces 29 without any free play ensures the sealing of the annular gap 19.

A differential ring nut 30 is arranged between the ring element 17 and the front ring element 21. The ring nut 30 comprises an outer thread 31 that extends in axial direction, and engages with a corresponding inner thread on a reduced section of the ring element 17. An inner thread 32 of the threaded nut concentric with the outer thread 31 spans the front ring element 21 and engages with a corresponding thread on its outer surface.

In a similar configuration as in the second embodiment, the two threads 31, 32 of the ring nut 30 comprise different pitches so that the turning of the ring nut by a certain angle induces an especially small and thus finely adjustable axial movement of the front ring element 21 in relation to the upper ring element 17 and thus of the lower or the inner ring element 22.

At least one axial groove with an inserted parallel spline 33 is provided between the upper ring element 17 and the front ring element 21. This provides an axial guiding element, which prevents a simultaneous turning, for example, of the front ring element 21, when the ring nut 30 is turned.

Based on the construction of the differential ring nut 30 between the front and upper ring elements, the arrangement of the tensioning element or a number of radial tensioning screws 23 is changed. In the third embodiment, the tensioning screws 23 do not press directly on the front ring element 21, but rather on the upper ring element 17. The tensioning screws 23 are bolted together or counter-positioned in a distancing ring 34 that is separate from the upper ring element 17. The distancing ring 34 and the upper ring element 17 together correspond approximately to the upper ring element 17 from FIG. 7, or to the first embodiment. On one of its sides, the distancing ring is firmly bolted to the distribution disk 13 and thus forms a wall of the hollow space 18. On its other end, the spacer ring 34 is firmly bolted with bolts 34a to the upper ring element 17. Because of a suitable configuration of these bolt connections, and because of the high pressing forces of the tensioning screws 23, there exists a sufficient possibility of a radial deformation of the upper ring element 17 and, through the adjacent surface 29, also of the front ring element 21 to allow a fine adjustment of the outlet in the peripheral direction. Just as in the first embodiment, here too, the tensioning screws are accessible also during the production so that the system can be fine-tuned during the production both by using the ring nut 30 and by means of the tensioning screws 23.

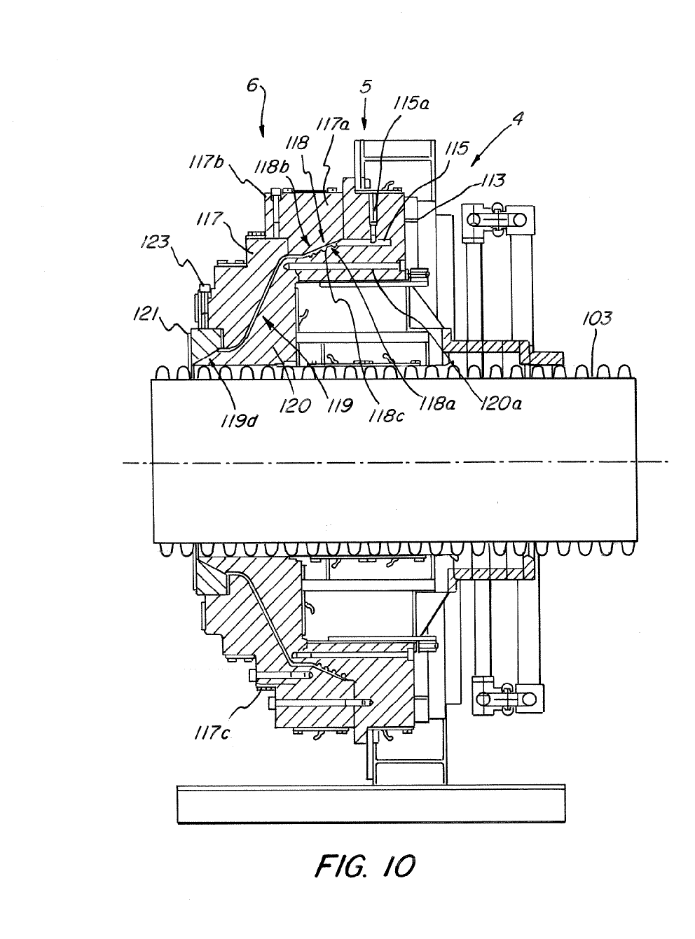

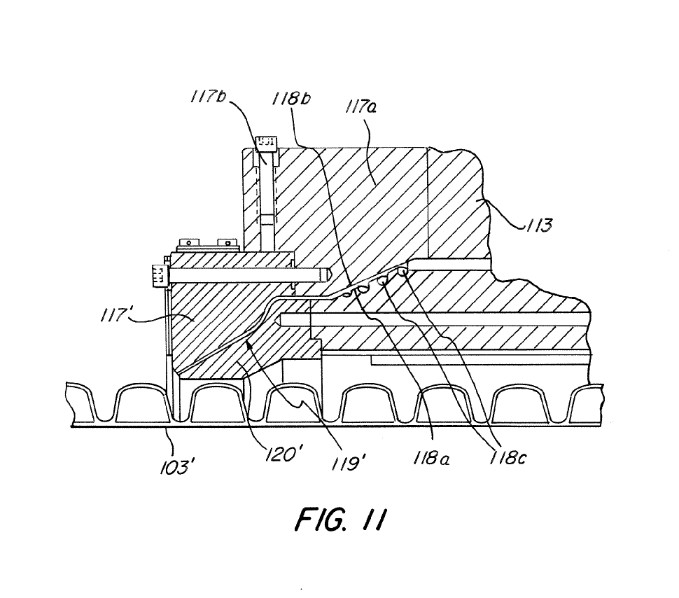

In another preferred embodiment of the invention shown in FIG. 10, the distribution area 5 comprises a hollow space 118, which has a different form from the hollow space of the first embodiment. This is essentially a ring space, which is delineated by an inner lateral wall 118a and an outer lateral wall 118b, each of which has the form of the surface of a cone segment. The inner lateral wall 118a comprises a number of spiral-shaped grooves 118c, which better distribute the plastic material that flows through the hollow space 118 analogously to the preceding embodiments of the invention.

The conical walls of the hollow space 118 are inclined inward in the radial direction and in the direction of the flow. The cone angle of the two walls is of the same size, but not identical. The angle of the outer lateral wall 118a relatively to the axial direction is about 22 degrees and the angle of the outer wall is greater by about 2.5 degrees. Therefore, in the flow direction of the plastic material, the distance between the lateral walls 118a, 118b somewhat increases.

Analogously to the first embodiment, the hollow space 118 is connected to the supply area 4 through a total of 32 supply channels 115. The supply area 4 is configured exactly as in the first embodiment. The supply channels 115 are configured as boreholes in a ring-shaped inner distribution part 113, which configures the inner lateral wall 118a of the hollow space 118. Also analogously to the first embodiment, the punched holes 115a are oriented in radial direction from outside towards the channels 115 in order to allow adjustment of the flowing cross-section of the individual channels by means of inserted adjustment screws.

The inner distribution part 113 is firmly bolted to an outer distribution part 117a, which configures the outer lateral walls 118b of the hollow space 118.

The hollow space 118, which mainly serves the purpose of homogenizing the flow of plastic material that is divided up among the 32 channels 115, flows into a annular gap 119. This gap is first configured between an outer ring element 117 and an inner ring element 112. The ring element 117 can be adjusted in radial direction by means of adjusting elements configured as tensioning screws 117b, and this is possible—depending on the requirements—by offsetting and/or by elastic deformation. In axial direction, the ring element 117 can be firmly bolted to the outer distribution part 117a using clamping screws 117c, and these screws are somewhat loosened in order to adjust the outer ring element 117.

The inner ring element 120 is firmly connected to the inner distribution element 113 by means of axial screws 120a that penetrate the inner distribution element 113.

In the example shown in FIG. 10, the outer ring element 117 is followed by another ring element 121, and the exit end 119d of the angular gap 119 is configured between the additional ring element 121 and the inner ring element 120. The additional ring element 121 can be adjusted in radial direction by means of setting elements 123 in the form of tensioning screws 123, and the tensioning screws 123 are retained or supported in the outer ring element 117 in a thread. This adds to the adjustability of the angular gaps 119 in its exit area 119d.

The corrugated pipe 103 shown in FIG. 10 has an inner diameter of 762 mm (30 inches, diameter up to the inner wall 103 coated with corrugated web). The diameter of the angular gap 119 at its exit end is about 890 mm. The smallest diameter of the hollow space 118, which must be measured at its exit end, is about 1,870 mm. This results in a relatively long course of the angular gap 119 so that the additional ring element is advantageous for adjustment.

In their entirety, the inner ring element 120, the outer ring element 117, and the additional ring element 121 form a set of ring elements, which—with other components of the device left unchanged—can be exchanged in the manner of a module.

FIG. 11 shows the same device as in FIG. 10, where, however, the illustrated first set of ring elements 117, 121, 121 has been replaced by a second set of ring elements 117′, 120′. The inner diameter of the outlet 119d is substantially greater, namely up to about 1,800 mm. The pipe 103′, accordingly, is a corrugated pipe with an inner diameter of 60 inches. Because of the proportionally shorter angular gap 119′, one of the ring elements and one adjusting option can be eliminated so that the nozzle area, or the angular gap 119, is now formed only by one inner ring element 120′ and an outer ring element 117′.

Depending on the set of ring elements arranged in the distribution area 104, a part with a different diameter made of plastic material can be coated. In the present embodiment, as shown, the endeavor is to cover at least the area of about 30 inches up to about 60 inches inner diameter of the corrugated pipe, for which only the sets of ring elements need to be exchanged.

1. A device for the application of plastic onto a workpiece, including
a supply area to supply fluid plastic,
a distribution area which follows the supply area in the flow direction of the plastic, and
a nozzle area which follows the distribution area, wherein a circular opening in the device is surrounded by an annular outlet in the nozzle area,
wherein a workpiece which is arranged within the opening is moveable in an axial direction as compared to the outlets and can be coated with the plastic over its entire circumference.

2. A device according to claim 1, wherein the supply area has a first, particularly tubular supply line wherein the first supply line branches into several secondary supply lines.

3. A device according to claim 2, wherein at least one of the secondary supply lines branches into several tertiary supply lines.

4. A device according to claim 2, wherein the supply area comprises several distribution channels which extend in the direction of the circumference of the circular opening.

5. A device according to claim 4, wherein the distribution channels are branched in at least one distribution plane.

6. A device according to claim 5, wherein the distribution level has several plate elements wherein the distribution channels are configured in the plate elements.

7. A device according to claim 6, wherein the plate elements are arranged sequentially in the axial direction.

8. A device according to claim 2, wherein the plastic flows from the supply area through at least sixteen, particularly at least thirty-two, channels which are distributed around the circumference of the opening, into the distribution area.

9. A device according to claim 1, wherein the distribution area possesses an annular hollow space, wherein the plastic flows into the hollow space through several supply channels which are distributed in the direction of the circumference and exits the hollow spaced via a circumferential annular gap.

10. A device according to claim 9, wherein the hollow space possesses a cross-section which narrows in the radial direction from the outside to the inside.

11. A device according to claim 10, wherein the cross-section essentially has the shape of a triangle that narrows in the radial direction from the outside to the inside.

12. A device according to claim 9, wherein the hollow space has a wall with several slit formed grooves.

13. A device according to claim 12, wherein the wall encloses an angle with a radial plane which is vertical to the axial direction, which is less than 45°, particularly less than 30°, particularly approximately between 18° and approximately 25°.

14. A device according to claim 9, wherein at least some, preferably all, of the supply channels have a throttle segment for adjustable changes to the cross-section of the channel.

15. A device according to claim 14, wherein the throttle elements each include a set screw which protrudes into the axial channel.

16. A device according to claim 14, wherein the throttle elements are distributed around the circumference of the device and adjustable from the outside, wherein in particular it becomes possible to adjust the throttle elements during the operation of the device.

17. A device according to claim 9, wherein the distribution area includes an annular distribution disk, wherein a wall of the hollow space is formed in an axial surface of the distribution disk.

18. A device according to claim 9, wherein the supply channels are formed as axial drill holes which are distributed around the circumference of the distribution disk.

19. A device according to claim 1, wherein the nozzle area has an annular gap that is essentially rotationally symmetrical in the axial direction, wherein the plastic flows from the distribution area through the annular gap to the outlet.

20. A device according to claim 19, wherein the annular gap possesses at least a first segment and a second segment, wherein the first segment runs axially and the second segment runs at an angle to the axial direction.

21. A device according to claim 20, wherein at least one of the two segments possesses a cross-section which narrows as it proceeds.

22. A device according to claim 21, wherein the first segment follows the distribution area and the second segment follows the first segment, wherein the second segment has conical walls with differing cone angles.

23. A device according to claim 19, wherein the annular gap has a back-up annular area wherein the backup annular area forms a locally narrowed cross-section of the annular gap.

24. A device according to claim 19, wherein the outlet is formed as the last segment of the annular gap, wherein the outlet has a conical wall which is radially tilted to the inside in the flow direction of the plastic.

25. A device according to claim 24, wherein the outlet possesses two conical walls with differing cone angles, wherein the cross-section of the outlet narrows in the flow direction of the plastic.

26. A device according to claim 1, wherein the outlet is formed between a first ring element and a second ring elements of the nozzle area.

27. A device according to claim 26, wherein the outlet can be changed through an adjustable mobility of at least one of the ring elements.

28. A device according to claim 27, wherein the mobility is provided through an elastic forming of the ring element particularly through the use of radially acting tensioning segments.

29. A device according to claim 28, wherein the tensioning segments include several radial tensioning screws which are distributed around the circumference of the ring element, wherein in particular the tensioning screws are adjustable during the operation of the device.

30. A device according to claim 26, wherein the first ring element and the second ring element are adjustable relative to each other in the axial direction.

31. A device according to claim 30, wherein a changeable spacer element is located on one of the ring elements to adjust the distance to the other ring element.

32. A device according to claim 30, wherein one of the ring elements is adjustable by means of at least one thread relative to the second ring element.

33. A device according to claim 32, wherein there is also a second thread, wherein the first and the second threads have different thread pitches.

34. A device according to claim 33, wherein a threaded ring which can be rotated for axial adjustment acts together with the two threads.

35. A device according to claim 30, wherein the first ring element and the second ring elements are conducted so as to be axially moveable in relation to each other.

36. A device according to claim 1, wherein heating devices to heat a surface of the workpiece are arranged on the device.

37. A device according to claim 1, wherein at least one elastic scraper to glide along the workpiece is arranged on the device.

38. A device according to claim 1, wherein the workpiece is a corrugated pipe, wherein the applied plastic forms a largely smooth outer wall of the corrugated pipe.

39. As device according to claim 38, wherein the corrugated piped possesses a smooth interior wall.

40. A device according to claim 1, wherein the plastic is a polyolefin.

41. A device according to claim 1, wherein the workpiece is a pipe with an external diameter of at least approximately 700 mm.

42. A device according to claim 41, wherein the external diameter of the pipe is more than approximately 1200 mm, particularly approximately 1700 mm.

43. A device according to claim 1, wherein the distribution area possesses a ring formed hollow space, wherein the plastic flows into the hollow space through several supply channels which are distributed around the circumference and exits the hollow space via a circumferential annular outlet.

44. A device according to claim 43, wherein the hollow space has an inner side wall which is formed on an inner distribution part and opposite this, an outer side wall which is formed on an outer distribution part, wherein each of the side walls largely has the form of a cone cut-off surface.

45. A device according to claim 44, wherein at least one groove which largely runs in the direction of the circumference is formed on at least one of the two side walls, particularly on the inner side wall).

46. A device according to claim 44, wherein an angle between one of the side walls and the axial direction measures between 10 degrees and 45 degrees, particularly approximately from 20 to approximately 30 degrees.

47. A device according claim 44, wherein the cone cut-off shaped side walls have differing cone angles, wherein the difference between the cone angles is not more than approximately 5 degrees, particularly approximately 3 degrees.

48. A device according to claim 44, wherein the annular gap is, at least in segments, formed between an inner ring element and an outer ring element, wherein the outer ring element is formed so as to be adjustable by means of an adjusting device.

49. A device according to claim 48, wherein the adjusting device includes a radially acting adjusting part which is supported against the outer distribution part.

50. A device according to claim 48, wherein an end section of the annular gap is delimited by a further ring element.

51. A device according to claim 50, wherein the further ring element is adjustable by means of an adjusting device.

52. As device according to claim 51, wherein the adjusting device includes a radially acting adjusting part which is particularly supported against the outer ring element.

53. A device according to claim 48, wherein the annular hollow space possesses a diameter of more than 1700 mm, particularly more than 1800 mm.

54. A device according to claim 53, wherein the annular gap possesses a diameter of more than 1600 mm, particularly more than 1700 mm, on an exit end.

55. A device according to claim 1, comprising a first set of ring elements and at least one second set of ring elements, wherein each of the sets of ring elements is detachably fastened to the distribution area and the outlet is formed by the respective set of ring elements which is fastened to the distribution area.

56. A device according to claim 55, wherein the first set of ring elements possesses an initial diameter of an exit end of the outlet, which differs from a corresponding second diameter of the exit end of the outlet on the second set of ring elements.

57. A device according to claim 55, wherein the first diameter is greater than approximately 1600 mm, particularly greater than approximately 1700 mm.

58. Device according to claim 56, wherein the second diameter is less than approximately 1200 mm, particularly smaller than approximately 1000 mm.

59. A device according to claim 55, wherein the number of ring elements in the first set of ring elements differs from the number of ring elements in the second set of ring elements.

60. A method for producing a plastic corrugated pipe, comprising the following steps:
A. Feeding a plastic corrugated pipe into a device according to claim 1;
B. Applying a plastic layer onto the inserted corrugated pipe using the device.

61. A plastic corrugated pipe produced using the method as in claim 60.

62. A plastic corrugated pipe according to claim 61, wherein the applied plastic layer forms a largely smooth outer wall of the corrugated pipe.
